(19) United States
(12) Patent Application Publication
(10) Pub. No.: US 2011/0271179 A1
(43) Pub. Date: Nov. 3, 2011

(54) METHODS AND SYSTEMS FOR GRAPHICALLY VISUALIZING TEXT DOCUMENTS

(75) Inventors: PETER JASKO, London (GB); SZABOLCS VERTES, Budapest (HU)

(73) Assignee: PETER JASKO, LONDON (GB)

(21) Appl. No.: 13/092,927

(22) Filed: Apr. 23, 2011

Related U.S. Application Data
(60) Provisional application No. 61/329,085, filed on Apr. 28, 2010.

(51) Int. Cl. G06F 17/24

(52) U.S. Cl. 715/256

(57) ABSTRACT

The present invention generally relates to methods and systems for processing and visualization management of text documents. More particularly, the present invention pertains to design and implementation of a method with enhanced qualitative and quantitative parameters for processing and automated visualization management of text documents and systems thereof.

### CROSS-REFERENCE TO RELATED APPLICATIONS

This application claims the benefit of the following provisional application, which is hereby incorporated by reference in its entirety: U.S. Provisional Patent Application No. 61/329,085, filed Apr. 28, 2010.

### BACKGROUND OF THE INVENTION

1. Field of the Invention

The present invention generally relates to methods and systems for processing and visualization management of text documents. More particularly, the present invention pertains to design and implementation of a method with enhanced qualitative and quantitative parameters for processing and automated visualization management of complex text documents and systems thereof.

2. Description of the Related Art

In general, visualization of data is used in data analysis to help the user in getting an initial idea about the raw data as well as visual representation of the regularities obtained in the analysis.

In particular, visualization of textual data is challenging. More specifically, automatic visualization of textual data in natural language text documents involving automated text processing poses a major challenge. For example, from the automated text-processing standpoint, natural language is very redundant in the sense that many different words share a common or similar meaning. This is problematical for computer to understand without some background knowledge.

In certain applications, legal documents have a structure beyond reading, such as a newspaper article. Like source code, which has definitions for one or more methods (or functions), legal documents also have one or more Defined Terms (or DTs) that depend on the definitions of the DTs.

In certain such application circumstances, there are numerous problems associated with the analysis and comprehension (or interpretation) of legal documents. For example, understanding a legal document requires keeping track of one or more DTs, the corresponding definitions and the relationships thereof. Specifically, visualizing and representing structure of the DTs, the corresponding definitions and the relationships thereof to aid comprehension of lengthy legal documents is a rather complicated task.

In many such applications, problems are related to consumption of input resources, such as capital, time and manpower, in the processes of searching and highlighting portions of legal documents.

Yet, in such application circumstances, assortments of problems are associated with modification of legal documents. For example, changing or modifying a legal document requires mental models of the relationships between the definitions. Still for example, in certain sizes of documents, such as those exceeding 20 pages, it becomes difficult to maintain a complete mental model (or map) of the definitions and relationships thereof. In certain specific circumstances, modifications to one or more complex definitions in a given legal document result in a cascade effect.

In certain other applications, automatic visualization and graphical representation of natural language documents involves automation of one or more processes including, but not limited to, data analysis, data visualization, data representation, which pose numerous problems. This is due to the fact that natural language provides expressive power but little support for automation.

In certain such application circumstances, visualization and graphical representation of text documents in natural language also poses major problems. This is due to the fact that documents in natural language give freedom and expressive power, but little support for visualization and automated syntactic and semantic checking.

The prior art is replete with numerous methods, apparatuses and systems for processing of text documents. However, they fail to disclose methods, apparatuses and systems for advanced processing and visualization management of text documents.

Accordingly, there is a need in the art for methods with enhanced qualitative and quantitative parameters for processing and visualization of text documents and systems thereof. More specifically, there is a need for the design and implementation of a method with enhanced qualitative and quantitative parameters for processing and automated visualization of text documents and systems thereof. Still more specifically, there is a need for the design and implementation of a method with enhanced qualitative and quantitative parameters, such as context-sensitivity or context-dependency, improved accuracy, better efficiency, reliability, reusability, minimal user intervention or maximal automation or minimal manual functionality, easy operability or minimized complexity or ease-of-implementation, enhanced readability and timeliness, for context-sensitive processing and automated visualization of text documents and systems thereof.

### SUMMARY OF THE INVENTION

In certain aspects of the invention, a method for automated graphical visualization of defined terms in legal documents comprising acts of searching defined terms, defined terms usages and defined term's definition text in the legal document, analyzing links between the defined terms and representing graphically the defined terms and links between the defined terms of the legal document, is disclosed.

In certain other aspects of the invention, a computer readable medium having stored thereon computer executable instructions that when executed by a processor of a computer, performs acts comprising searching defined terms, defined terms usages and defined term's definition text in the legal document, analyzing links between the defined terms and representing graphically the defined terms and links between the defined terms of the legal document, is disclosed.

In yet other aspects of the invention, a method for organizing definitions of documents, the method comprises pre-parsing the document to extract formatting information of the document, searching definitions, definition's text and references of definitions in the document, analyzing relationships between the definitions and displaying definitions and relationships between the definitions in a graphical tree-structure, is disclosed.

Still, in certain aspects of the invention, a computer-implemented system for automated graphical visualization of definitions in documents, the system comprising a searching component that searches definitions, definition's text and definition's references in the document, an analysis component that analyzes references between the definitions and a display component that displays definitions and references between the definitions in a graphical tree-structure, is disclosed.

Still further, in certain aspects of the invention, methods for searching one or more references to Defined Terms (or DTs) in documents are disclosed, in accordance with the principles of the invention. Specifically, design and implementation of methods for searching one or more references to Defined Terms (or DTs) in documents using one or more tree data structures are disclosed. More specifically, design and implementation of one or more tree data structures thereby facilitating fast lookup for references to Defined Terms (or DTs) in documents are disclosed.

Yet, in certain aspects of the invention, a method for managing references to defined terms in documents, the method comprising creating a tree of defined terms found in at least one of a plurality of documents using stemmed words of the defined terms and implementing the tree for facilitating fast lookup for the references to the defined terms.

In certain such specific embodiments, a first level of the tree contains each of first stemmed words of the each of the defined terms as one or more child nodes thereof. Further, each of the one or more child nodes in the first level has one or more child nodes in a second level containing each of second stemmed word of the each of the defined terms, wherein each of the one or more child nodes in a second level has each of the one or more child nodes in the first level as parent nodes. Still further, an n-th level of the tree contains each of the n-th stemmed word of the each of the defined terms. Furthermore, each node of the tree corresponds to at least one of a defined term, a middle word in the defined term and the root node of the tree.

In use, in certain such specific embodiments, the phase of implementing the tree for facilitating fast lookup for the references to the defined terms in the documents involves examination of each word thereof. Specifically, in use, in certain such specific embodiments, the phase of implementing the fast lookup for facilitating for the references to the defined terms in the documents involving examination of each word thereof comprises implementation of at least one of the one or more distinct phases and all potential permutations and combinations of the phases thereof, in accordance with the principles of the invention. By way of example, and in no way limiting the scope of the invention, the following phases assigning the root node of the tree as a current node and a first word of the document as a current word, assigning the current node to the child node on determining a stemmed word of the current word is a child node of the current node, declaring that a reference is found on determining the stemmed word of the current word is not a child node of the current node and the current node corresponds to a defined term, resetting the current node to the root node on determining the stemmed word of the current word is not a child node of the current node, assigning the current word to a next word and reiterating the phases of the assigning the current node to the child node on determining a stemmed word of the current word is a child node of the current node, the declaring that a reference is found on determining the stemmed word of the current word is not a child node of the current node and the current node corresponds to a defined term and the resetting the current node to the root node on determining the stemmed word of the current word is not a child node of the current node.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagrammatic view of a system facilitating automated graphical visualization of text documents, designed and implemented in accordance with certain embodiments of the invention;

FIG. 2 is an exploded diagrammatic representation of the host computing subsystem, of FIG. 1, comprising a document pre-parsing module designed and implemented in accordance with at least some embodiments of the invention;

FIG. 3 is the exhaustive delineation of a second GUI provided by the graph browser sub-module, designed and implemented in accordance with certain embodiments of the invention;

FIG. 4A depicts a context flow diagram delineating at least one process implemented by the system configuration of FIGS. 1 and 2 thereby facilitating automated graphical representation of text documents; and

FIGS. 4B and 4C collectively depict a flow diagram delineating at least one process implemented by the system configuration of FIGS. 1 and 2 thereby facilitating automated graphical representation of text documents.

### DETAILED DESCRIPTION

Certain general embodiments of the invention disclose a computer-implemented system for automated graphical visualization of definitions in documents, the system comprising a searching component that searches definitions, definition's text and definition's references in the document, an analysis component that analyzes references between the definitions and a display component that displays definitions and references between the definitions in a graphical tree-structure.

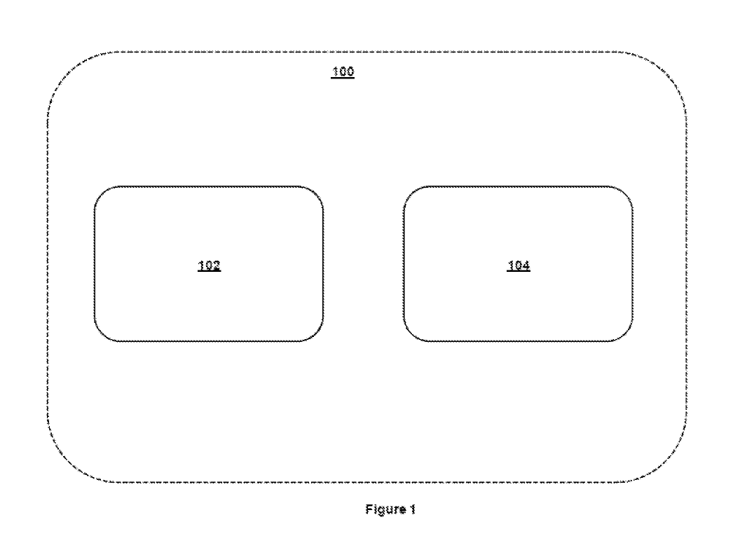

FIG. 1 is a block diagrammatic view of an exemplary system facilitating implementation of one or more processes for automated graphical visualization of text documents, designed and implemented in accordance with certain embodiments of the invention.

System 100 is in essence an Automated Text Document Graphical Visualization System (or ATDGVS). The ATDGVS 100 may involve or encompass a host computing subsystem 102 and a display subsystem 104.

In certain embodiments, the ATDGVS 100 may provide a system configuration for practicing the principles of the invention. Specifically, ATDGVS 100 may provide the system configuration for practicing a method of processing and visualization management of text documents.

In certain specific embodiments, the ATDGVS 100, by virtue of its design, may facilitate processing and visualization management of text documents. Specifically, the ATDGVS 100 may facilitate implementation of a method with enhanced qualitative and quantitative parameters for processing and automated graphical visualization of complex text documents. Still more specifically, the ATDGVS 100 may facilitate implementation of the method with enhanced qualitative and quantitative parameters, such as improved accuracy, better efficiency, reliability, reusability, minimal user intervention or maximal automation or minimal manual functionality, easy operability or minimized complexity or ease-of-implementation, enhanced readability and timeliness, for context-sensitive processing and automated graphical visualization of complex text documents.

As used in computing, the terms “addin,” “plugin,” “plug-in,” “add-in,” “addon,” “snap-in” or “snapin” refer to a computer program that interacts with a host application, for example a web browser or an email client, to provide a certain, usually very specific, function “on demand”. Add-on is often considered the general term comprising plug-ins, extensions, and themes as subcategories.

As used in computing, the term “software extension” refers to a computer program designed to be incorporated into another piece of software in order to enhance or extend the functionalities of the latter. On its own, the program is not useful or functional. Examples of software applications that support extensions include the Mozilla Firefox Web Browser, Adobe Systems Photoshop and Microsoft Windows Explorer shell extensions. It is common to find that applications whose scope is potentially unbounded will feature an extensions interface Application Programming Interface (or API), and the API description will often be published so that third-party developers can produce extensions.

As used in computing, the term “application software”, also known as software application, application or app, refers to computer software designed to help the user to perform a singular or multiple related specific tasks. Typical examples are word processors, spreadsheets, media players and database applications.

In the context of this disclosure, the terms “desktop application” or “standalone software application” and “web application,” “web-based software application” or “web-enabled software application” refer to one or more forms of the ATDGVS. Specifically, the term “desktop application” or “standalone software application” refers to a first version or form of the ATDGVS that is adapted to (or capable of) working offline, i.e. does not necessarily require network connection to function. On the contrary, the term “web application,” “web-based software application” or “web-enabled software application” refers to a second version of form of the ATDGVS that is capable of being accessed via the internet over a network, such as the Internet or an intranet.

As used in computing, the term “Software as a Service or SaaS” refers to a model of software deployment over the internet. With SaaS, a provider licenses an application to customers for use as a service on demand, either through a time subscription or a “pay-as-you-go” model. Also known as “software on demand,” the SaaS model allows vendors to develop, host and operate software for customer use. Rather than purchase the hardware and software to run an application, customers need only a computer or a server to download the application and internet access to run the software. The software can be licensed for a single user (i.e. single user license) or for a group of users (i.e. multiuser license).

In certain embodiments, the ATDGVS may possess one or more distinct modes of implementation. In certain such embodiments, the ATDGVS can be implemented as at least one of application software and a software extension or addin through partial human intervention. In certain such embodiments, the ATDGVS may have one or more versions or forms. In certain implementations involving a first version, the ATDGVS may be adapted to (or capable of) working offline, i.e. may not necessarily require network connection to function. However, in certain implementations involving a second version, the ATDGVS may be accessed via the internet over a network, such as the Internet or an intranet. By way of example, and in no way limiting the scope of the invention, certain specific implementations involving the second version may deploy the ATDGVS as SaaS.

In certain specific embodiments, the ATDGVS can be launched through partial human intervention (or partially manually) or automatically. By way of example, and in no way limiting the scope of the invention, the ATDGVS can be launched from at least one of a Microsoft Windows desktop application software and Microsoft Word addin. Note must be taken of the fact that a major feature of the Office suite is the ability for users and third party companies to write add-ins (or plug-ins) that extend the capabilities of an application by adding custom commands and specialized features. For example, the types of add-ins supported differ by Office versions: Office 97 onwards (standard Windows DLLs i.e. Word WLLs and Excel XLLs), Office 2000 onwards (COM add-ins), Office XP onwards (COM/OLE Automation add-ins) and Office 2003 onwards (Managed code add-ins-VSTO solutions).

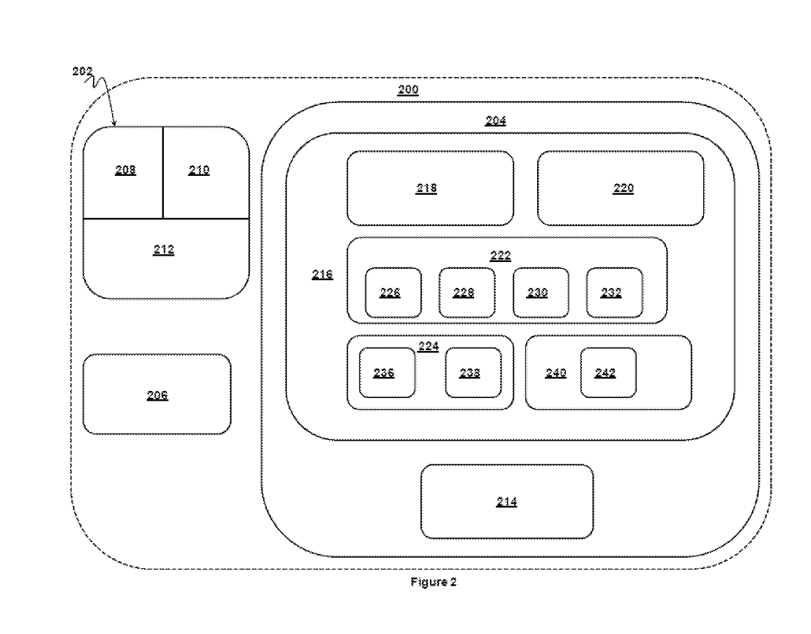

FIG. 2 is an exploded diagrammatic representation of the host computing subsystem, of FIG. 1, comprising a document pre-parsing module designed and implemented in accordance with at least some embodiments of the invention.

Host computing subsystem 200 may comprise a processing unit 202, a memory unit 204 and an Input/Output (or I/O) unit 206 respectively.

Host computing subsystem 200, by virtue of its design and implementation, may facilitate overall management of ATDGVS 100 of FIG. 1.

Processing unit 202 may comprise an Arithmetic Logic Unit (or ALU) 208, a Control Unit (or CU) 210 and a Register Unit (or RU) 212.

As shown in FIG. 2, the memory unit 204 may comprise a document acquisition module 214, a document pre-parsing module 216 and a graphical representation module 240.

Document acquisition module 214 is in essence a document selection module. Document selection module 214 may facilitate selection of one or more documents. Specifically, the document selection module 214 may facilitate implementation of a method allowing selection of one or more documents by a user. More specifically, the document selection module 214 may facilitate implementation of a method allowing creation of a group or project comprising one or more documents selected by a user through implementation of one or more distinct modes of selection.

In certain embodiments, a given created group or project may be a dynamic or mutable set of one or more documents.

In operation, the document selection module 214 may provide a first Graphics User Interface (or GUI) (not shown explicitly) thereby facilitating selection of one or more documents by a user. Specifically, the first GUI may facilitate selection of one or more documents by a user thereby resulting in the formation of a group or project.

By way of example, and in no way limiting the scope of the invention, each document is an electronic file, such as a Microsoft Word document, a text-based PDF document or another document that can readily be converted into a text document.

As used in computer GUIs, the term “drag-and-drop” refers to the action of (or support for the action of) clicking on a virtual object and dragging it to a different location or onto another virtual object. In general, it can be used to invoke many kinds of actions, or create various types of associations between two abstract objects. As a feature, support for drag-and-drop is not found in all software, though it is sometimes a fast and easy-to-learn technique for users to perform tasks. However, the lack of affordances in drag-and-drop implementations means that it is not always obvious that an item can be dragged.

In operation, the basic sequence involved in drag-and-drop is press, and hold down, the button on the mouse or other pointing device, to grab the object, drag the object/cursor/pointing device to the desired location, drop the object by releasing the button. For example, dragging an icon on a virtual desktop to a special trashcan icon to delete a file. Further examples include, but are not limited to, dragging a data file onto a program icon or special window for viewing or processing, moving or copying files to a new location/directory/folder, adding objects to a list of objects to be processed, rearranging widgets in a graphical user interface to customize their layout, dragging a command onto an object to which the command is to be applied, e.g. dragging a color onto a graphical object to change its color, dragging a tool to a canvas location to apply the tool at that location, creating a hyperlink from one location or word to another location or document. Still further, most text editors allow dragging selected text from one point to another.

In certain specific embodiments, the GUI may provide a drag-and-drop facility to select one or more documents for processing.

In human-computer interaction, cut and paste and copy and paste offer user-interface paradigms for transferring text, data, files or objects from a source to a destination. Most ubiquitously, users require the ability to cut and paste sections of plain text. This paradigm has close associations with graphical user interfaces that use pointing devices such as a computer mouse (by drag and drop, for example).

As shown in FIG. 2, in certain specific embodiments, the document selection module 214 may be coupled to the document pre-parsing module 216.

In certain specific embodiments, a given predefined project consisting of given selection of documents may be processed (i.e. pre-parsed) by the document pre-parsing module, in accordance with the principles of the invention. In certain such embodiments, the document pre-parsing module may facilitate implementation of a method for pre-parsing the given project in one or more distinct modes. Specifically, in such embodiments, the aforementioned method may possess one or more distinct modes of operation depending on one or more distinct scenarios in connection with the processing (i.e. pre-parsing) of the given dynamic or mutable set of documents. Further, the aforementioned method may be implemented at any given time, wherein the number of documents in the set of documents at any given time may be at least one. Still further, the aforementioned method may facilitate implementation of one or more distinct operations thereby facilitating modification of given predefined dynamic or mutable set of documents.

Document pre-parsing module 216, by virtue of its design, may facilitate implementation of a method for pre-parsing of the project, wherein the method may be capable of being implemented in one or more distinct modes.

As used in computing and digital media, the term “formatted text, styled text or rich text,” as opposed to plain text, has styling information beyond the minimum of semantic elements, such as colors, styles (i.e. boldface, italic), sizes and special features, such as hyperlinks. Formatted text cannot rightly be identified with binary files or be distinct from ASCII text. This is because formatted text is not necessarily binary, it may be text-only, such as HTML, RTF or enriched text files, and it may be ASCII-only. Conversely, a plain text file may be non-ASCII (in an encoding such as Unicode UTF-8). Text-only formatted text is achieved by markup which too is textual, while some editors of formatted text like Microsoft Word save in a binary format.

In general, binary files contain formatting information that only certain applications or processors can understand. While humans can read text files, binary files must be run on the appropriate software or processor before humans can read the same. For example, only Microsoft Word and possibly other word processing programs can handle the formatting information in a Word document. For example, executable files, compiled programs, Statistical Analysis System (or SAS) and Statistical Package for the Social Sciences (or SPSS) system files, spreadsheets, compressed files, and graphic (image) files and the like are binary files.

In certain other specific embodiments, a given predefined dynamic or mutable set of documents may be pre-parsed thereby facilitating extraction of relevant information while removal or rejection of other (or irrelevant) information. Specifically, in certain such embodiments, the relevant information may comprise typographical information, such as formatting and text information. More specifically, the relevant typographical formatting and text information may comprise punctuation information, formatting information, page information and text with punctuation information. In certain implementations involving specific embodiments, the punctuation information may include at least one and all potential permutations and combinations of one or more punctuation marks or characters selected from a group comprising apostrophe, brackets, colon, comma, dashes, ellipses, exclamation mark, full stop/period, guillemets, hyphen, question mark, quotation (i.e. open and close) marks, semicolon, slash/stroke, solidus and the like. By way of example, and in no way limiting the scope of the invention, in such scenarios, the punctuation information may include at least one and all potential permutations and combinations of one or more punctuation marks or characters selected from a group consisting of punctuation marks or characters, such as quotation (i.e. open and close) marks, parentheses and brackets. Likewise, the formatting information may comprise font and heading formatting information. By way of example, and in no way limiting the scope of the invention, in certain such embodiments, the font formatting information may include bold font formatting. Still likewise, in such embodiments, the heading formatting information may include one or more styles.

It must be noted that the aforementioned extraction of relevant (or context-sensitive or context-dependent) information while removal or rejection of other information may be implemented implicitly or explicitly. Stated differently, the aforementioned extraction of relevant (or context-sensitive or context-dependent) information while removal or rejection of other information may be at least one of system (i.e. ATDGVS)-defined and user-defined.

As depicted in FIG. 2, in certain specific embodiments, the document pre-parsing module 216 may consist of a document pre-processing sub-module 218, an intra-document Potential Defined Term (or PDT) search sub-module 220, a Potential Defined Term (or PDT) test sub-module 222 and a fast lookup sub-module 224.

In certain specific embodiments, the given predefined dynamic or mutable set of documents may be subjected to transformation from a given input form to an intermediate form, in accordance with the principles of the invention. In certain such embodiments, each of the given predefined dynamic or mutable set of documents may be subjected to transformation from a given input form to an intermediate form through design and implementation of the document pre-processing module. Specifically, the given predefined dynamic or mutable set of documents may be pre-processed thereby facilitating transformation of the each of the given predefined dynamic or mutable set of documents from a given input form to an intermediate form.

Reiterating again, in certain other specific embodiments, a given predefined dynamic or mutable set of documents is pre-parsed thereby facilitating extraction of relevant information while removal or rejection of other (or irrelevant) information. Specifically, in certain such embodiments, the extracted relevant information comprises typographical information, such as formatting and text information. More specifically, the relevant typographical formatting and text information comprises punctuation information, formatting information, page information and text with punctuation information. For example, the punctuation information may include at least one and all potential permutations and combinations thereof selected from a group comprising one or more punctuation marks or characters, such as apostrophe, brackets, colon, comma, dashes, ellipses, exclamation mark, full stop/period, guillemets, hyphen, question mark, quotation (i.e. open and close) marks, semicolon, slash/stroke, solidus and the like. By way of example, and in no way limiting the scope of the invention, in certain specific embodiments, the punctuation information includes at least one and all potential permutations and combinations thereof selected from a group consisting of punctuation marks or characters, such as quotation (i.e. open and close) marks, parentheses and brackets. Likewise, the formatting information may comprise font and heading formatting information. By way of example, and in no way limiting the scope of the invention, in certain such embodiments, the font formatting information includes bold font formatting. Still likewise, in such embodiments, the heading formatting information may include one or more styles. More specifically, the intermediate form comprises at least one of all text transitions to bold font formatting and italic font formatting, all page transitions, such as markers for page transitions to enable page counting, all heading markers and paragraph numbering.

Document pre-processing sub-module 218, by virtue of its design, may facilitate transformation of the given predefined dynamic or mutable set of documents from a given input form to an intermediate form. Specifically, the document pre-processing sub-module 218 may facilitate implementation of a method for transformation of each of the given predefined dynamic or mutable set of documents from the given input form to an intermediate form.

In operation, the document pre-processing sub-module 218 may facilitate implementation of the method for extraction of relevant (or context-sensitive or context-dependent) information while removal or rejection of other (or irrelevant) information.

As shown in FIG. 2, in certain specific embodiments, the document pre-processing sub-module 218 may be coupled to the intra-document PDT search sub-module 220.

In certain other specific embodiments, the given predefined dynamic or mutable set of documents may be searched thereby facilitating discovery (or location or detection) of one or more PDTs. In certain such embodiments, the given predefined dynamic or mutable set of documents may be searched thereby facilitating discovery (or location or detection) of one or more PDTs, wherein the search conducted on a given document of the predefined dynamic or mutable set of documents depends on looking for (or seeking) one or more portions of the text in the given document that are delimited by one or more punctuation marks or characters.

As used herein, the term “Defined Term (or DT)” refers to a sequence of words used to mean or refer to another (typically longer) sequence of words, even if (occasionally, by accident) such other sequence is not present in the document or document set. For example, in certain scenarios, the X in a definition, such as ‘“X” means y.”’ is considered a DT. In yet another example, use of a capitalized word in the middle of a sentence, e.g. House in a definition, such as ‘“Each party will build a House.”’ In certain such scenarios, the defined term may be missing a definition.

As used in general, the term “Defined Term (or DT)” refers to a shorthand reference within a document that refers to another name or idea in the document. The standard convention in legal documents is to define terms in double quotes and designate subsequent references with initial capital letters. For example, as in Exhibit 99.2 to Morgan Stanley Form 8-K dated Mar. 31, 2006, “Owner and Servicer shall not disclose any confidential or proprietary information of the other party with respect to such other party, the Mortgage Loans, or the Mortgage Files that may be in the possession of that party (the ‘“Confidential Information”’) to any Person who is not a partner, officer, employee, counsel, or agent of such party except with the written consent of such other party or pursuant to a subpoena or order issued by a court or by an administrative, legislative, or law enforcement agent, department, agency, body or committee.”

In this passage, the term ‘“Confidential Information”’ becomes a DT by being set forth in double quotes following the text to which it refers. Subsequent references (”usages“) to Confidential Information (with initial caps but without quotation marks) will be deemed to mean “any confidential or proprietary information of the other party with respect to such other party, the Mortgage Loans, or the Mortgage Files that may be in the possession of that party.” In the paragraph above, ,, “Owner,”’0 ‘“Servicer,”’ ‘“Mortgage Loans,”’ ‘“Mortgage Files,”’ and ‘“Person”’ are usages of DTs which are (presumably) defined elsewhere in the document.

Grammatically, the definition above is set forth as an appositive that is a noun that follows another noun to explain or identify it. Another drafter might have written ‘hereinafter referred to as the ‘“Confidential Information”’ or something similar.

As used in the current context the term “definition” refers to the combination of a defined term and its definition text e.g. ‘“X” means y.’

Likewise, the term “definition text”, as used in the current context, refers to the body or text of the definition e.g. the ‘“y” in: ‘“X” means y.’

Further, as used in the current context, the term “use or reference” with respect to a given DT refers to the occurrence of the given DT in the definition text of a definition (commonly a different definition from that of the used DT) or in the non-definition part of a document.

Still further, as used in the current document, the term “orphan Defined Term or orphan DT” refers to a given DT that is either not used or used but not defined or a closed set (i.e. no use of defined terms) of defined terms, that are not used.

Also, as used in the current context, the terms “document set,” “set of documents,” “project,” “case” or “legal file” refer to a set of documents grouped together.

The term “clause” typically refers to a numbered section of a document consisting of one or more paragraphs.

Intra-document PDT search sub-module 220, by virtue of its design, may facilitate searching of the predefined dynamic or mutable set of documents thereby facilitating discovery (or location or detection) of one or more PDTs. Specifically, the intra-document PDT search sub-module 220 may facilitate implementation of a method for searching the predefined dynamic or mutable set of documents for detection of one or more PDTs.

In operation, in certain specific embodiments, the intra-document PDT search sub-module 220 may facilitate implementation of the method for searching the predefined dynamic or mutable set of documents for detection of one or more PDTs. In here, the search for the PDTs relies on seeking one or more portions of the text in the given document that are delimited by one or more punctuation marks or characters. By way of example, and in no way limiting the scope of the invention, the search for the PDTs relies on seeking one or more portions of the text in the given document that are delimited by quotation marks comprising at least one of an open quotation mark, a close quotation mark and all potential permutations and combinations thereof. For example, ,, “Portfolio”“ means a portfolio of loan securities. In certain scenarios, open quotation marks that are not closed by closed quotation marks are identified as DT“s with names not exceeding a certain length.

Specifically, in operation the intra-document PDT search sub-module 220 may facilitate looping through each word in the document for detection and selection of one or more ranges (or arrays) of words confined to one or more sections. More specifically, the intra-document PDT search sub-module 220 may facilitate selection of the one or more ranges of words in the one or more sections that are heterogeneously emphasized with one or more given fonts in one or more given styles. Still more specifically, the intra-document PDT search sub-module 220 may provide for selection of the one or more ranges of words that are homogeneously emphasized with a given font in a given style, in opposition to, the font of the rest of the text in a given section of the document. By way of example, and in no way limiting the scope of the invention, looping through each word in the document facilitates selection of one or more range of words that are homogeneously emphasized, such as with a bold font in a given non-bold section, an italic font in a given non-italic section.

As used in computer science, the term “looping” refers to executing the same set of instructions a given number of times or until a specified result is obtained. Specifically, as used in computer programming, the term “looping” refers to control loops including the main event loop.

In certain specific embodiments, as shown in FIG. 2, the intra-document PDT search sub-module 220 may be coupled to the PDT test sub-module 222.

In certain embodiments, one or more PDT ranges are subjected to test for validation of one or more definitions. Specifically, each of the one or more PDT ranges is tested whether it is a definition. More specifically, for a given PDT the test for validation of definition may comprise selection of a given paragraph to which a given PDT range is confined to. In certain circumstances, one or more paragraphs are selected to which one or more PDT ranges are confined to. Specifically, in certain such circumstances, the paragraph selection may be extended to include one or more consecutive or contiguous paragraphs to capture a given definition, which extends over one or more paragraphs.

As used in general, the term “definition” refers to a passage describing the meaning of a term, a word or phrase or other set of symbols. The term to be defined is the definiendum (plural definienda). A term may have many different senses or meanings. For each such specific sense, a definiens (plural definientia) is a cluster of words that defines it.

As used in the current context, the term “definition delimiter” refers to at least one punctuation character selected from a group including space, colon and open and close quotation mark.

As used in general, the term “section” refers to a self-contained part of a larger written composition.

PDT test sub-module 222, by virtue of its design, may facilitate test of one or more PDT ranges for existence and validation of one or more corresponding definitions. Specifically, the PDT test sub-module 222 may facilitate implementation of a method for testing each of the one or more PDT ranges as to whether it is a definition. More specifically, for a given PDT the test for existence and validation of definition may comprise selection of a given paragraph to which a given PDT range is confined to. In certain circumstances, one or more paragraphs are selected to which one or more PDT ranges are confined to. Specifically, in certain such circumstances, the paragraph selection may be extended to include one or more consecutive or contiguous paragraphs to capture a given definition, which extends over one or more paragraphs.

In certain specific embodiments, as depicted in FIG. 2, the PDT test sub-module 222 may consist of a paragraph splitter component 226, a Definition Match Text Generator (or DMTG) component 228, a Regular Expression Rules Generator (or RRG) component 230, a comparator component 232 respectively.

In certain embodiments, a paragraph splitter sub-unit may facilitate splitting of given one or more selected paragraphs into one or more portions, in accordance with the principles of the invention.

Paragraph splitter component 226, by virtue of its design, may facilitate splitting of given one or more selected paragraphs into one or more portions. By way of example, and in no way limiting the scope of the invention, the paragraph splitter component 226 of the PDT test sub-module 222 may facilitate splitting of a given selected paragraph into three sections. For purposes of clarity and expediency, the three sections of the selected paragraph have been mentioned herein as a Prefix Range, a Keyword Range and a Postfix Range, in that order.

In operation, in certain such embodiments, the paragraph splitter component 226 may facilitate splitting of given selected paragraph into three sections, namely the Prefix Range, Keyword Range and Postfix Range, in that order.

The term “Keyword Range”, as used in the current context, refers to a given Potential Defined Term Range (or PDTR) adapted to discard or ignore all punctuation characters, barring at least a pair of definition delimiters positioned at the start and end of the given PDTR.

Further, as used in the current context, the term “Prefix Range” refers to everything in a given selected paragraph prior to the Keyword Range.

Still further, as used in the current context, the term “Postfix Range” refers to everything in a given selected paragraph subsequent to the Keyword Range.

In certain embodiments, the DMTG component may facilitate generation or construction of one or more Definition Match Texts (or DMTs). In certain such embodiments, the DMTs are constructed by concatenation of the given Prefix Range, Keyword Range and Postfix Range.

As shown in FIG. 2, in certain specific embodiments, the paragraph splitter component 226 may be coupled to the DMTG component 228.

DMTG component 228, by virtue of its design, may facilitate generation or construction of one or more DMTs. Specifically, the DMTG component 228 may facilitate implementation of a method for construction of a given DMT by concatenation of the given Prefix Range, Keyword Range and Postfix Range.

In operation, in certain such embodiments, the output of the DMTG component 228 may be supplied as input to the PDT test sub-module 222. The PDT test sub-module 222 may facilitate testing of the DMT. Specifically, the PDT test sub-module 222 may facilitate implementation of a method for testing the DMT, wherein the given Keyword Range is subjected to one or more test cases comprising one or more criteria. More specifically, the given Keyword Range is subjected to at least three given test cases comprising at least one criterion based on the presence or absence of given one or more distinct scenarios. By way of example, and in no way limiting the scope of the invention, the given Keyword Range is subjected to three test cases such that each of the three test cases involves one criterion. For purposes of clarity and expediency, the three test cases have been referred herein as first, second and third respectively. The first test case involves testing of the given Keyword Range against a given first scenario based on the presence or absence of no content in the given Keyword Range, i.e. the given Keyword Range is devoid of content. Likewise, the second test case involves testing of the given Keyword Range against a given second scenario based on the presence or absence of a single character. Still likewise, the third test case involves testing of the given Keyword Range against a given third scenario based on the presence or absence of an initial lower case character. In certain situations, the given Keyword Range may not pass each of the three test cases successfully. In such situations, the given Keyword Range is ignored or discarded from the standpoint of a potential definition.

Yet, in certain other situations, the given Keyword Range may pass each of the aforementioned three test cases successfully. In such situations, the PDT test sub-module 222 may facilitate comparison of the given DMT versus a given set of Regular Expressions (or REGEXs).

As used in computing, the term “Regular Expressions”, also referred to as regex or regexp or RegEx, refers to a concise and flexible means for matching strings of text, such as particular characters, words, or patterns of characters. A regular expression is written in a formal language that can be interpreted by a regular expression processor, a program that either serves as a parser generator or examines text and identifies parts that match the provided specification. A RegEx is a string that is used to describe or match a set of strings according to certain syntax rules. The specific syntax rules vary depending on the specific implementation, programming language, or library in use. Additionally, the functionality of regex implementations can vary between versions.

Despite the variability, and because regular expressions are difficult to both explain and understand without examples, the following discussion provides a basic description of some of the properties of regular expressions, by way of illustration.

Note must be taken of the fact that the following conventions are used in the examples. Firstly, the term “metacharacter(s)” refers to the metacharacters column that specifies the regex syntax being demonstrated. Secondly, the term “=˜ m//” refers to a regex match operation in Perl. Thirdly, the term “=˜ s///” refers to a regex substitution operation in Perl. Also worth noting is that these regular expressions are all Perl-like syntax. Standard POSIX regular expressions are different.

Table 1 below depicts a tabular representation of examples in connection with the illustration of RegExs. Unless otherwise stated, the following examples conform to the Perl programming language. The syntax and conventions used in these examples may coincide with that of other programming environments as well.

| | | EXAMPLE |
|---|---|---|
| META- | | (Note that all the if |
| CHARAC- | | statements return a |
| TER(S) | DESCRIPTION | TRUE value) |
| . | Normally matches any | $string1 = “Hello |
| | character except a | World\n”; |
| | newline. Within square | if ($string1 =~ m/...../) { |
| | brackets the dot is | print “$string1 has |
| | literal. | length >= 5\n”; |
| | | } |
| ( ) | Groups a series of | $string1 = “Hello |
| | pattern elements to a | World\n”; |
| | single element. When | if ($string1 =~ |
| | you match a pattern | m/(H..).(o..)/) { |
| | within parentheses, you | print “We matched ‘$1’ |
| | can use any of $1 , $2, . . . | and ‘$2’\n”; |
| | later to refer to the | } |
| | previously matched | Output: |
| | pattern. | We matched ‘Hel’ and ‘o |
| | | W’; |
| + | Matches the preceding | $string1 = “Hello |
| | pattern element one or | World\n”; |
| | more times. | if ($string1 =~ m/l+/) { |
| | | print “There are one or |
| | | more consecutive letter |
| | | \“l\”'s in $string1\n”; |
| | | } |
| | | Output: |
| | | There are one or more |
| | | consecutive letter “l”'s |
| | | in Hello World |
| ? | Matches the preceding | $string1 = “Hello |
| | pattern element zero or | World\n”; |
| | one times. | if ($string1 =~ m/H.?e/) { |
| | | print “There is an ‘H’ |
| | | and a ‘e’ separated by |
| | | ”; |
| | | print “0-1 characters |
| | | (Ex: He Hoe)\n”; |
| | | } |
| ? | Modifies the *, +, or | $string1 = “Hello |
| | {M,N}'d regexp that | World\n”; |
| | comes before to match | if ($string1 =~ |
| | as few times as | m/(l.+?o)/) { print “The |
| | possible. | non-greedy match with |
| | | ‘l’ followed by one or ”; |
| | | print “more characters |
| | | is ‘llo’ rather than ‘llo |
| | | wo’.\n”; |
| | | } |
| * | Matches the preceding | $string1 = “Hello |
| | pattern element zero or | World\n”; |
| | more times. | if ($string1 =~ m/el*o/) { |
| | | print “There is an ‘e’ |
| | | followed by zero to |
| | | many ”; |
| | | print “‘l’ followed by ‘o’ |
| | | (eo, elo, ello, elllo)\n”; |
| | | } |
| {M,N} | Denotes the minimum | $string1 = “Hello |
| | M and the maximum N | World\n”; |
| | match count. | if ($string1 =~ m/l{1,2}/) |
| | | { |
| | | print “There exists a |
| | | substring with at least 1 |
| | | ”; |
| | | print “and at most 2 l's |
| | | in $string1\n”; |
| | | } |
| [...] | Denotes a set of | $string1 = “Hello |
| | possible character | World\n”; |
| | matches. | if ($string1 =~ |
| | | m/[aeiou]+/) { |
| | | print “$string1 contains |
| | | one or more vowels.\n”; |
| | | } |
| \| | Separates alternate | $string1 = “Hello |
| | possibilities. | World\n”; |
| | | if ($string1 =~ |
| | | m/(Hello\|Hi\|Pogo)/) { |
| | | print “At least one of |
| | | Hello, Hi, or Pogo is ”; |
| | | print “contained in |
| | | $string1.\n”; |
| | | } |
| \w | Matches an | $string1 = “Hello |
| | alphanumeric character, | World\n”; |
| | including “_”; same as | if ($string1 =~ m/\w/) { |
| | [A-Za-z0-9_] | print “There is at least |
| | | one alphanumeric ”; |
| | | print “character in |
| | | $string1 (A-Z, a-z, 0-9, |
| | | _)\n”; |
| | | } |
| \s | Matches a whitespace | $string1 = “Hello |
| | character (space, tab, | World\n”; |
| | newline, form feed) | if ($string1 =~ m/\s.*\s/) |
| | | { |
| | | print “There are TWO |
| | | whitespace characters, |
| | | which may”; |
| | | print “ be separated by |
| | | other characters, in |
| | | $string1”; |
| | | } |
| \hat{ } | Matches the beginning | $string1 = “Hello |
| | of a line or string. | World\n”; |
| | | if ($string1 =~ m/\hat{ }He/) { |
| | | print “$string1 starts |
| | | with the characters |
| | | ‘He’\n”; |
| | | } |
| [\hat{ }...] | Matches every | $string1 = “Hello |
| | character except the | World\n”; |
| | ones inside brackets. | if ($string1 =~ m/[\hat{ }abc]/) |
| | | { |
| | | print “$string1 contains |
| | | a character other than ”; |
| | | print “a, b, and c\n”; |
| | | } |
| | x | Multiplication operator |

In certain specific embodiments, generation of one or more rules for construction of one or more RegExs through employment of a RRG component, designed and implemented in accordance with the principles of the invention, is disclosed.

RRG component 230, by virtue of its design, may facilitate generation of one or more rules for construction of one or more RegExs. Specifically, the RRG component

In certain specific embodiments, the RRG component 230 may be coupled to at least one of the PDT test sub-module 222, the DMTG component 228, the comparator component 232 and all possible permutations and combinations thereof.

In operation, in such embodiments, the output of the RRG component 230 (i.e. the pair of RegExs) may be utilized for comparison with a given DMT.

In certain specific embodiments, the comparison of a given DMT with one or more RegExs is facilitated through employment of the comparator component, designed and implemented in accordance with the principles of the invention.

Comparator component 232, by virtue of its design, may facilitate comparison of a given DMT with one or more RegExs. Specifically, the comparator component 232 may facilitate implementation of a method for comparison of a given DMT with one or more RegExs.

In operation, in such embodiments, the comparator component 232 is fed with the output of the RRG component 230 (i.e. the pair of RegExs) and the output of the DMTG component 228 (i.e. a given DMT). Specifically, the comparator component 232 may facilitate implementation of a method for comparison of the given DMT versus the pair of RegExs generated through implementation of the pair of rules, namely RegEx Rule 1 and RegEx Rule 2. By way of example, and in no way limiting the scope of the invention, the RegEx Rule 1 is illustrated by the following Expression 1:

̂((\w+\s*) {0,3} |.+ or ) [“,,”“]?xKEYWORDx[“,,”“]?\s* (or|means|is|has the meaning|[:]),

Likewise, the RegEx Rule 2 is illustrated by the following Expression 2:

[(](\w+\s*) {0,3} [“,,”“]?xKEYWORDx[“,,”“]?[)].

As used in software engineering, the term “data model” refers to an abstract model that describes how data are represented and accessed. Data models formally define data elements and relationships among data elements for a domain of interest. A data model is a wayfinding tool for both business and IT professionals, which uses a set of symbols and text to precisely explain a subset of real information to improve communication within the organization and thereby lead to a more flexible and stable application environment. A data model explicitly determines the meaning of data, which in this case is known as structured data (as opposed to unstructured data, for example an image, a binary file or a natural language text, where the meaning has to be elaborated). Typical applications of data models include database models, design of information systems, and enabling exchange of data. Usually data models are specified in a data modeling language.

In certain specific embodiments, a data model for a given document is constructed in tandem with (or in synchronization with) the search for PDTs within the given document. Specifically, the data model may comprise one or more DT objects. More specifically, the one or more DT objects may comprise one or more references amid the one or more DT objects and references to one or more definition texts thereof.

In certain such embodiments, the links are analyzed amid the one or more DTs to complete an object model for the given document.

As used in computing, the term “lookup” usually refers to searching a data structure for an item that satisfies some specified property. For example, variable lookup performed by a scripting language interpreter, virtual machine or other similar engine usually consists of performing certain actions to dynamically find correspondence between variable identifier and actual variable internal representation, usually involving symbol table lookup. Symbol table lookup can be performed either during run-time by interpreter or scripting engine, or during compile time by compiler. A hybrid scheme when lookup is performed both during translation phase and then later during runtime is also possible (e.g. bytecode compiler and virtual machine). In all of these cases, search item is a variable and the search property (or search criterion) is a variable name. Variable lookup is usually performed according to variable visibility rules that are specific to the scripting language in question.

As used in computer science, the term “index” refers to an integer which identifies an array element or a data structure that enables sublinear-time lookup. An index is any data structure which improves the performance of lookup. There are many different data structures used for this purpose, and in fact a substantial proportion of the field of computer science is devoted to the design and analysis of index data structures. There are complex design trade-offs involving lookup performance, index size, and index update performance. Many index designs exhibit logarithmic (O(log (N)) lookup performance and in some applications it is possible to achieve flat (O(1)) performance. One specific and very common application is in the domain of information retrieval, where the application of a full-text index enables rapid identification of documents based on their textual content.

In general, the concept of fast lookup is illustrated by the following example. Considering a data store containing N data objects, wherein it is desired to retrieve one of the N data objects based on the value of one of the data object's fields or attributes. In certain average case scenarios involving a naive implementation, each data object is retrieved and examined until a match is found. In certain other best case scenarios involving implementation of a successful lookup, on average half of the total number of data objects, i.e. N/2, are retrieved and examined. Still, in certain worst case scenarios involving implementation of unsuccessful lookup, all of the data objects are retrieved and examined for each of the attempts. Thus, performance is O(N) or linear time. Since data stores commonly contain millions of objects and since lookup is a common operation, it is often desirable to improve on this performance.

In certain embodiments, fast lookup may be facilitated by a fast lookup sub-module, designed and implemented in accordance with the principles of the invention.

As shown in FIG. 2, in certain such embodiments, the fast lookup sub-module 224 may comprise an index data structure 234 (not shown here explicitly), a Stemmed Composite Word Generator (or SCWG) component 236 and a search component 238.

In certain embodiments, fast lookup may be facilitated through design and implementation of one or more index data structures. In certain such embodiments, the fast lookup may be facilitated through design and implementation at least one index data structure loaded or inputted with one or more DTs based on one or more criteria. More specifically, the index data structure is loaded or inputted with one or more DTs based on at least a pair of criterion. By way of example, and in no way limiting the scope of the invention, the one or more DTs are inserted into the index data structure based on a pair of criterion, namely a first and a second criterion. In accordance with the first criterion the one or more DTs are loaded in the index data structure based on the number of words in a given DT. Still, in accordance with the second criterion the one or more DTs are loaded in the index data structure alphabetically by DTs (i.e. based on ascending order of first alphabetical character in one or more DTs). In certain scenarios, at least one criterion of the pair of criterion may be dependent on the other independent criterion. In certain such scenarios, the order of implementation of the pair of criterion may be initiated from the independent criterion to the dependent criterion.

Yet, in certain specific embodiments, each word in a given document of the predefined mutable or dynamic set of documents may be subjected to iterative processing facilitated through design and implementation of customized process-specific systems.

Fast lookup sub-module 224, by virtue of its design, may facilitate fast lookup of given one or more valid definitions through implementation of one or more index data structures for managing (i.e. storing and organizing) the one or more valid definitions. By way of example, and in no way limiting the scope of the invention, the given one or more valid definitions are managed through implementation of at least one index data structure.

The term “queue” refers to a particular kind of collection in which the entities in the collection are kept in order and the principal (or only) operations on the collection are the addition of entities to the rear terminal position and removal of entities from the front terminal position. This makes the queue a First-In-First-Out (or FIFO) data structure. In a FIFO data structure, the first element added to the queue will be the first one to be removed. A queue is an example of a linear data structure.

The term “First-In-First-Out or FIFO” refers to an abstraction in ways of organizing and manipulation of data relative to time and prioritization. This expression describes the principle of a queue processing technique or servicing conflicting demands by ordering process by First-Come, First-Served (or FCFS) behaviour: what comes in first is handled first, what comes in next waits until the first is finished, etc.

However, a practical implementation of a queue, e.g. with pointers, of course does have some capacity limit, that depends on the concrete situation it is used in. For a data structure the executing computer will eventually run out of memory, thus limiting the queue size. Queue overflow results from trying to add an element onto a full queue and queue underflow happens when trying to remove an element from an empty queue.

As used in computing, the terms “associative array,” “associative container,” “map,” “mapping,” “dictionary” or “finite map,” and in query-processing an “index” or “index file” refer to an abstract data type composed of a collection of unique keys and a collection of values, where each key is associated with one value (or set of values). The operation of finding the value associated with a key is called a lookup or indexing, and this is the most important operation supported by an associative array.

In certain embodiments, the design and implementation of one or more index data structures is disclosed. In certain specific embodiments, the index data structure is implemented as an array of one or more maps. By way of example, and in no way limiting the scope of the invention, the index data structure may be implemented as an array of one or more maps, wherein each of the one or more maps may be an associative array. For purposes of clarity and expediency, the array of the maps may be referred to as a DT index. Each map in the array is keyed in with the string concatenated from the words in a given DT. For example, for a given DT, i.e. ‘“Additional Machine Tool”’, the word ‘“Additional Machine Tool”’ goes into a map in the 3rd location of corresponding array of the maps, with a key of ‘“Additional Machine Tool”’.

In certain specific embodiments, the DT index possesses the following specifications: size or length of the queue is MaxWords; items or entities of the DT index are words.

As used herein, the term “MaxWords” refers to the largest number of words in a given DT across a given dynamic or mutable set of documents, i.e. document set.

As used in computer science, the term “static memory allocations” refers to the process of allocating memory at compile-time before the associated program is executed, unlike dynamic memory allocation or automatic memory allocation where memory is allocated as required at run-time.

Likewise, as used in computer science, the term “dynamic memory allocation” (also known as heap-based memory allocation) is the allocation of memory storage for use in a computer program during the runtime of that program. It can be seen also as a way of distributing ownership of limited memory resources among many pieces of data and code.

Reiterating again, fast lookup is facilitated through implementation of one or more index data structures for managing (i.e. storing and organizing) given one or more valid definitions. Specifically, the given one or more valid definitions are inputted to the index data structure based on one or more criteria. More specifically, the given one or more valid definitions are inputted to the index data structure based on at least a pair of criterion. For purposes of clarity and expediency, the pair of criterion has been referred herein as a first and second criterion respectively, wherein based on the first criterion the given one or more valid definitions are inputted to the index data structure by number of words in a given DT, and wherein based on the second criterion the given one or more valid definitions are inputted to the index data structure alphabetically by DT.

In operation, in such embodiments, the fast lookup sub-module 224 may facilitate implementation of one or more processes comprising one or more phases thereby resulting in insertion of given one or more valid definitions to the index data structure. By way of example, and by no way of limitation, the given one or more valid definitions are inputted to the index data structure based on at least a pair of criterion. For purposes of clarity and expediency, the pair of criterion has been referred herein as a first and second criterion respectively, wherein based on the first criterion the given one or more valid definitions are inputted to the index data structure by number of words in a given DT, and wherein based on the second criterion the given one or more valid definitions are inputted to the index data structure alphabetically by DT. Specifically, in operation, in such embodiments, each word in a given document of the given set of dynamic of mutable documents is inserted in the index data structure in which the length or size of the index data structure is MaxWords.

In certain specific embodiments, the ordered FIFO queue may possess the following specifications: size or length of the queue is MaxWords; items or entities of the queue are words; number of terminal positions or pointers is two (or 2), i.e. front and rear.

In use, in certain embodiments, the ordered FIFO queue is implemented to generate potential keys that can be looked up in the DT index.

In certain specific embodiments, one or more memory locations may be allocated for the implementation of the ordered FIFO queue using one or more memory allocation techniques, in accordance with the principles of the invention. In such embodiments, the one or more memory locations may be allocated using dynamic or automatic memory allocation technique. Specifically, in such embodiments, the one or more memory locations allocated to the queue may be at least equal to the MaxWord. By way of example, and in no way limiting the scope of the invention, the length or size of the queue equals the value of MaxWord. More specifically, each of the memory locations of the ordered FIFO queue stores one of the one or more words of a given DT, i.e. MaxWord number of words of a given DT. For purposes of clarity and expediency, the one or more words of a given DT stored in the queue may be referred herein as first word, second word, third word and so on to MaxWord-th word respectively, where MaxWord is the length or size of the queue.

As used in linguistic morphology, the term “stemming” refers to the process for reducing inflected (or sometimes derived) words to their stem, base or root form, generally a written word form. The stem need not be identical to the morphological root of the word; it is usually sufficient that related words map to the same stem, even if this stem is not in itself a valid root. The process of stemming, often called conflation, is useful in search engines for query expansion or indexing and other natural language processing problems. Stemming programs are commonly referred to as stemming algorithms or stemmers.

Likewise, the term “word stem”, as used in linguistics, refers to a stem (sometimes also theme) is a part of a word. The term is used with slightly different meanings.

In certain applications, a stem is a form to which affixes can be attached. For example, in such applications, the English word “friendships” contains the stem friend, to which the derivational suffix “-ship” is attached to form a new stem “friendship”, to which the inflectional suffix “-s” is attached. In certain such specific applications, the root of the word, for example friend, is not counted as a stem.

Still, in certain other applications, a word has a single stem, namely the part of the word that is common to all its inflected variants. Thus, in such applications, all derivational affixes are part of the stem. For example, the stem of “friendships” is “friendship”, to which the inflectional suffix “-s” is attached.

Stems may be roots, e.g. run, or they may be morphologically complex, as in compound words, such as the compound nouns “meat ball” or “bottle opener”, or words with derivational morphemes, such as the derived verbs “black-en” or “standard-ize”. Thus, the stem of the complex English noun “photographer” is “photo•graph•er”, but not “photo”. In yet another example, the root of the English verb form “destabilized” is “stabil-”, a form of stable that does not occur alone; the stem is de•stabil•ize, which includes the derivational affixes “de-” and “-ize”, but not the inflectional past tense suffix “-(e)d”. That is, a stem is that part of a word that inflectional affixes attach to.

As used in the current context, the term “stemmed” refers to capturing a mapping from the original word into the stem of the original word using a local language spelling and dictionary module.

In certain specific embodiments, the generation of one or more stemmed composite words is disclosed in accordance with the principles of the invention. In certain such embodiments, the generation of one or more stemmed composite words from the ordered FIFO queue may be facilitated through design and implementation of Stemmed Composite Word Generator (or SCWG).

In certain specific embodiments, the fast lookup sub-module may facilitate generation of one or more stemmed composite words and search (or detection) for each of the generated stemmed composite words in the queue through employment of a SCWG component and a search component, designed and implemented in accordance with the principles of the invention. In such embodiments, at least one of the generation of stemmed composite words, the detection of the same and all potential permutations and combinations thereof is dependent on one or more circumstances or scenarios thereof. In certain circumstances, the generation of one or more stemmed composite words is dependent on one or more distinct states of the queue. In certain specific circumstances, the generation of one or more stemmed composite words is not initiated until a given criterion based on at least one distinct state of the queue is met. By way of example, and in no way limiting the scope of the invention, the generation of one or more stemmed composite words is not initiated until a given criterion based on (or associated with) one distinct state, i.e. queue is full, of the queue is met. For purposes of clarity and expediency, the full state of the queue is referred herein as a first state of the queue. Likewise, in certain other specific circumstances, few stemmed composite words are generated at the end of reading of a given document based on at least another distinct criterion. By way of example, and in no way limiting the scope of the invention, few stemmed composite words are generated based on a second distinct criterion, i.e. queue is not full. Still, in certain specific circumstances, both the generation of stemmed composite words and detection are overridden based on at least a yet another distinct criterion associated with the elements of the queue (i.e. one or more words of a given DT) and a keyword of a given definition (i.e. the DT of the given definition). By way of example, and in no way limiting the scope of the invention, both the generation of stemmed composite words and detection are overridden based on a third criterion, wherein at least one of the one or more words in the queue are detected inside a keyword of a given definition, i.e. the DT itself. In yet another specific circumstances, the generation of stemmed composite words and detection are overridden based on at least a fourth distinct criterion associated with the elements of the queue (i.e. one or more words of a given DT). By way of example, and in no way limiting the scope of the invention, both the generation of stemmed composite words and detection are overridden based on the fourth criterion, wherein a first word of the one or more words in the queue is not capitalized.

SCWG component 236, by virtue of its design, may facilitate generation of one or more stemmed composite words from the ordered FIFO queue. Specifically, the SCWG component 236 may facilitate implementation of a method for generation of one or more stemmed composite words from the ordered FIFO queue.

In operation, in such embodiments, the SCWG component 236 may facilitate implementation of the method for generation of one or more stemmed composite words from the ordered FIFO queue. Specifically, the one or more stemmed composite words are generated by employing the ordered FIFO queue based on one or more factors associated with the queue and the elements thereof. More specifically, the one or more stemmed composite words are generated by employing the ordered FIFO queue based on at least a pair of factors associated with the queue and the elements thereof. By way of example, and by no of limitation, the pair of factors consists of the length or size of the queue, i.e. MaxWord or number of words in a given DT, and the elements of the queue, i.e. words of the given DT stored in the queue.

In certain specific embodiments, the one or more stemmed composite words are generated by employing the ordered FIFO queue based on one or more factors, in accordance with the principles of the invention.

By way of example, and in no way limiting the scope of the invention, the one or more words constituting a given DT form the length or size of the FIFO queue.

In operation, in such embodiments, no stemmed composite words may be generated through the deployment of the SCWG component 236 till the queue is full, i.e. the length or size of queue is MaxWord. In certain scenarios involving one or more specific states associated with the ordered FIFO queue, fewer stemmed composite words may be generated. By way of example, and in no way limiting the scope of the invention, fewer stemmed are generated at the end of the document reading, if the queue is not full, i.e. the queue is in at least one of empty and partially empty state.

In certain specific embodiments, the ordered FIFO queue may facilitate implementation of one or more methods for overall management of the queue and the elements thereof. For example, and by no way of limitation, the queue may facilitate implementation of the following one or more methods to verify one or more states of queue, i.e. queue overflow, queue underflow, queue empty and the like; to retrieve the addresses of a pair of pointers, i.e. a front and rear; to insert (or push) and delete (or pop) elements to and from the queue and to calculate the total number of elements of the queue.

In operation, in such embodiments, generation of the one or more stemming composite words may involve insertion of the one or more words of a given DT in the ordered FIFO queue. The SCWG module 236 may facilitate deletion of the one or more words of the given DT from the queue for generation of the one or more stemming composite words. In certain embodiments, the one or more stemming composite words are generated by concatenation of at least one or more words selected from a group comprising one or more selected combinations of the one or more words of the given DT. In certain specific embodiments, the one or more stemming composite words are generated by concatenation of at least one or more words selected from a group comprising at least a total of number of the one or more selected combinations equal to the total number of words of the given DT in the ordered queue.

As used in computer science, the term “search algorithm” refers to an algorithm for finding an item with specified properties among a collection of items. The items may be stored individually as records in a database; or may be elements of a search space defined by a mathematical formula or procedure, such as the roots of an equation with integer variables; or a combination of the two, such as the Hamiltonian circuits of a graph.

As used in computer science, the term “binary search or binary search algorithm” refers to an algorithm for locating the position of an element in a sorted list. It inspects the middle element of the sorted list: if equal to the sought value, then the position has been found; otherwise, the upper half or lower half is chosen for further searching based on whether the sought value is greater than or less than the middle element. The method reduces the number of elements needed to be checked by a factor of two each time, and finds the sought value if it exists in the list or if not determines “not present”, in logarithmic time. A binary search is a dichotomic divide and conquer search algorithm.

In certain specific embodiments, each generated stemmed composite word is considered in descending or decreasing order of number of words (i.e. longest stemmed composite word) therein. Specifically, the one or more words of each generated stemmed composite word are in essence at least one of one and more words of a given DT retrieved (or popped) from the queue. In certain such embodiments, if each of the generated stemmed composite word is in the index data structure then a definition reference (called a Reference) is recognized as found and the appropriate additions are made to the object model. In certain scenarios involving such embodiments, if the search is successful then the remaining searches are skipped and ignored.

In certain specific embodiments, graphical representation of a given generated object model may be facilitated through the design and implementation of a graphical representation module, in accordance with the principles of the invention. In certain such embodiments, the graphical representation module may facilitate implementation of one or more data structures thereby facilitating graphical representation of a given generated object model by using a graph browser sub-module. By way of example, in no way limiting the scope of the invention, the data structure is a tree.

In certain such embodiments, the tree comprises one or more nodes. In certain situations, the tree initially exhibits only the top (or apex) level nodes. However, each node can be opened individually to show the next level of nodes.

As depicted in FIG. 2, the graphical representation module 240 may consist of a graph browser sub-module 242 and a tree data structure 244 (not shown herein).

In certain specific embodiments, the graph browser sub-module 242 provides a GUI thereby facilitating overall management of the tree.

In certain embodiments, the display subsystem 104 of FIG. 1 may be coupled to the I/O unit 206 of FIG. 2.

In certain specific embodiments, the process of finding all usages of one or more DTs and definitions of the one or more DTs is disclosed, in accordance with the principles of the invention.

In certain scenarios involving the aforementioned embodiments, one or more usages of DT definition may be at least one of the following forms:

Quotes ,,”

Quotes+bold

Bold only

Table style [x][y].

In certain other scenarios involving one or more instances of the DT definition texts, the one or more DT definition texts may be at least one of the following expressions: ,,x” means y; ,,x” is y; ,,x” means y and y . . . (,,x”). In such scenarios, emphasis is finding the definition text, in entirety, for a given DT.

The following are three common styles or types of definition texts:

Style 1. “x” means y;

Style 2. y . . . (“x”); and

Style 3. (collectively “x”)

Style 4. ,,x” shall mean y; and

Style 5. ,,x” shall not . . . y.

Still, in certain specific embodiments, one or more rules are disclosed in connection with the DT definition text. By way of example, and in no way limiting the scope of the invention, a pair of rules may be implemented in connection with the DT definition text.

For purposes of clarity and expediency, the pair of rules has been referred herein as first and second rules.

In accordance with the first rule, if text is detected after a given DT name, use that as DT text. The said text is considered up to the following one or more parameters, such as next DT name, next heading, end of sentence and the like.

Likewise, as per the second rule, if no text is detected after a given DT name, then use text before the given DT name, up to: a previously given DT name (ignore this rule if Style 3 is used), beginning of sentence and the like.

Further, finding one or more DT usages comprises consideration of one or more situations. By way of example, and in no way limiting the scope of the invention, the consideration of one or more situations may involve detection of all capitalized words based on one or more criterion. Firstly, if a capitalized letter is detected at beginning of sentence or proper noun (needs dictionary: England, London, This, The, If . . . and the like) then ignore unless it matches a DT with a definition.

Secondly, if all the letters are capitalized, e.g. THE SECURED LOAN SHALL . . . then ignore unless it matches a DT with a definition. Thirdly, ignore headings.

In other situations, the DT consists of one or more compound words: For example, ,,Secured Loan” - ,,Secured”, ,,Loan”; Account; Secured Loan; Secured Loan Account. An attempt is always made to identify the longest DT from a given set of words.

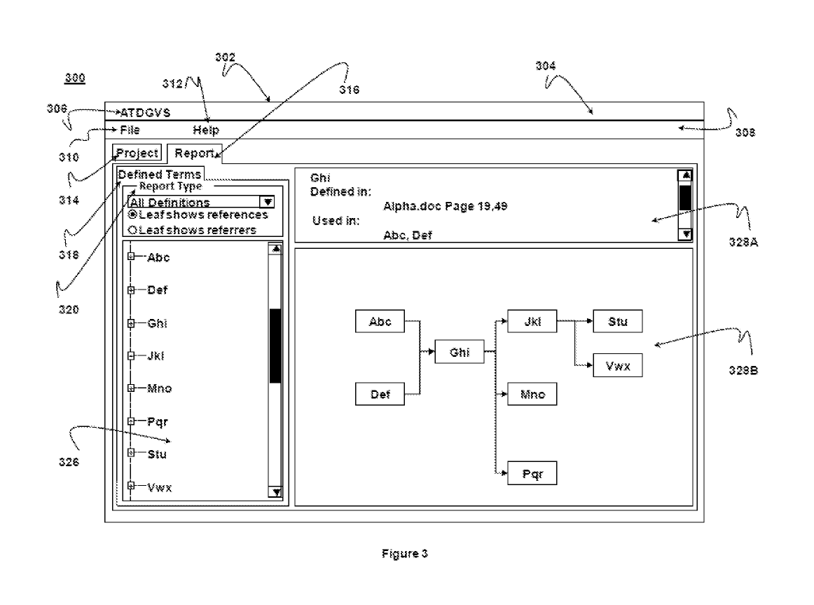

FIG. 3 is the exhaustive delineation of a second GUI provided by the graph browser sub-module, designed and implemented in accordance with certain embodiments of the invention.

As depicted in FIG. 3, the GUI 300 of the graph browser sub-module 242 of FIG. 2 may possess the following specifications: window 302 is the visual area; title bar 304 is at the top of the application window as a horizontal bar; default title bar text 306 is the name of the manufacturer and the application, such as “ATDGVS”; menu bar 308 includes at least one of one or more window-specific menus, one or more application-specific menus and all potential permutations and combinations thereof; number of menus in the menu bar is a pair of menus, 310 and 312, such as “File” and “Help”; pair of window tabs, 314 and 316, includes “Project” and “Reports” tabs; Reports tab 316 consists of “DTs” tab 318; DTs tab 318 consists of a frame 320 named “Report Type”, at least of list box and a combo box 320, a pair of radio buttons, 322 and 324, named “Leaf shows references” and “Leaf shows referrers”; a left window pane 326 comprising one or more DTs and a right window pane 328 consisting of a top section 328A and a bottom section 328B; the top section 328A of the right window pane 328 provides details in connection with a given DT, such as DT Keyword of the given DT, a target path or location of the given DT and miscellaneous details thereof, such as page numbers of text defining the given DT, i.e. definition and usage details of the given DT in one or more DTs and the bottom window pane 328B exhibits a tree or graph thereby facilitating graphical visualization of a given text document.

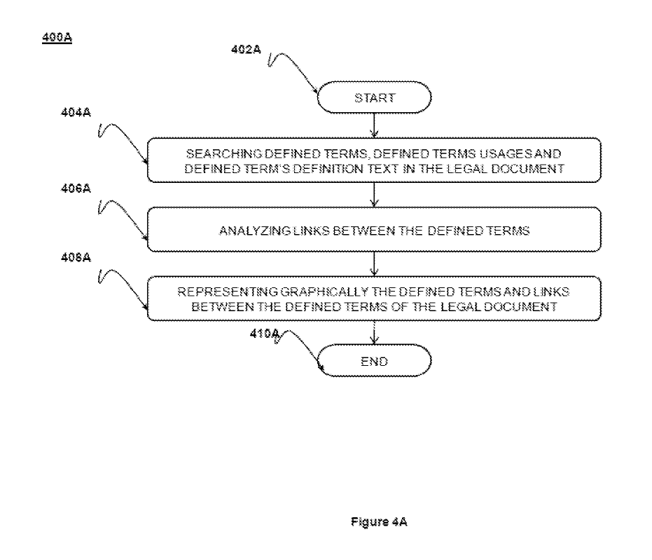

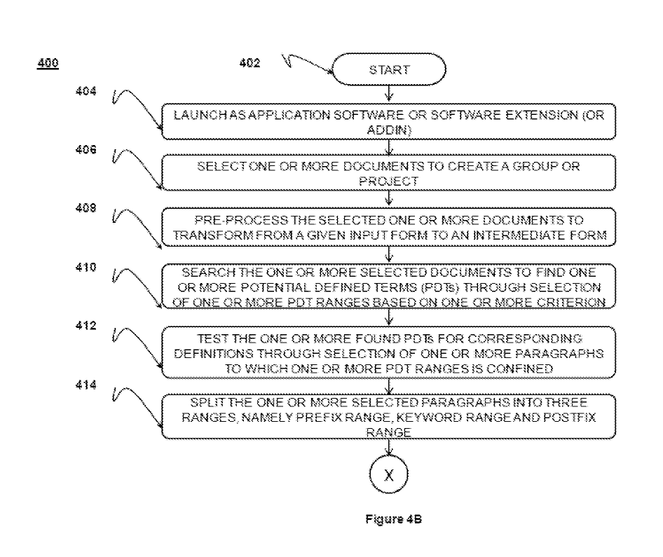

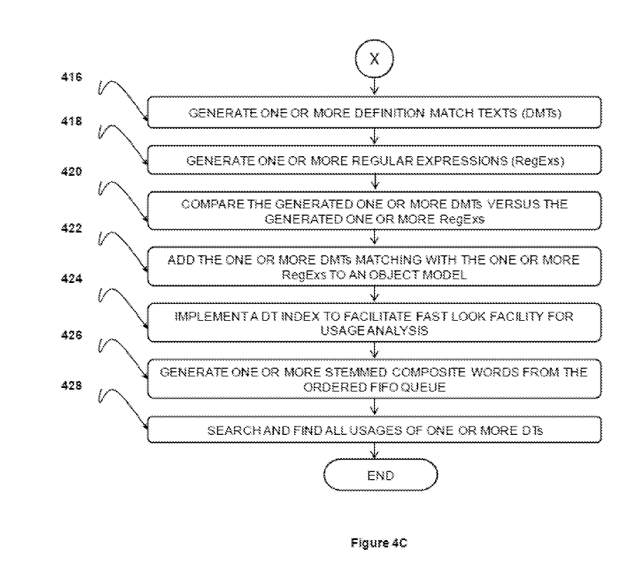

FIG. 4A depicts a context flow diagram delineating at least one process implemented by the system configuration of FIGS. 1 and 2 thereby facilitating automated graphical representation of text documents.

FIGS. 4B and 4C collectively depict a flow diagram delineating at least one process implemented by the system configuration of FIGS. 1 and 2 thereby facilitating automated graphical representation of text documents.

The process 400 starts at stage 402 and proceeds to stage 404, wherein the process 400 comprises the phase of implementation of the ATDGVS in one or more distinct modes. Specifically, the ATDGVS may be implemented in at least a pair of distinct modes. More specifically, the ATDGVS may be implemented in a pair of distinct modes, such as at least one of application software and a software extension or addin. By way of example, and in no limiting the scope of the invention, the ATDGVS can be launched from a Microsoft Word addin or directly from Microsoft Windows desktop.

At stage 406, the process comprises the phase of selection of one or more documents. Specifically, the phase of selection of one or more documents may be performed through partial user intervention by implementation of one or more distinct modes of selection. By way of example, and in no way limiting the scope of the invention, the selection of one or more documents results in creation of a group or project consisting of the one or more documents selected by the user through implementation of one or more distinct modes of selection. All other ins-and-outs in connection with the selection of the one or more documents facilitated through implementation of the document selection module 214 have already been delineated in conjunction with FIG. 2.

In certain embodiments, the process comprises the phase of pre-parsing the one or more documents thereby facilitating the extraction of relevant (or context-sensitive or context-dependent) information while removal or rejection of other (or irrelevant) information. Specifically, in certain such embodiments, the extracted relevant information comprises typographical information, such as formatting and text information. More specifically, the relevant typographical formatting and text information comprises punctuation information, formatting information, page information and text with punctuation information. For example, the punctuation information may include at least one and all potential permutations and combinations of one or more punctuation marks or characters selected from a group comprising an apostrophe, one or more brackets, a colon, comma, one or more dashes, ellipses, an exclamation mark, a full stop/period, guillemets, a hyphen, a question mark, one or more quotation (i.e. open and close) marks, semicolon, slash/stroke, solidus and the like. By way of example, and in no way limiting the scope of the invention, in certain specific embodiments, the punctuation information includes at least one and all potential permutations and combinations thereof selected from a group consisting of punctuation marks or characters, such as quotation (i.e. open and close) marks, parentheses and brackets. Likewise, the formatting information may comprise font and heading formatting information. By way of example, and in no way limiting the scope of the invention, in certain such embodiments, the font formatting information includes bold font formatting. Still likewise, in such embodiments, the heading formatting information may include one or more styles.

It must be noted that the aforementioned extraction of relevant (or context-sensitive or context-dependent) information while removal or rejection of other information may be implemented implicitly or explicitly. Stated differently, the aforementioned extraction of relevant (or context-sensitive or context-dependent) information while removal or rejection of other information may be at least one of system (i.e. ATDGVS)-defined and user-defined.

In certain specific embodiments, the phase of pre-parsing comprises implementation of one or more sub-phases in one or more distinct sequences, in accordance with the principles of the invention.

At stage 408, the phase of pre-parsing comprises the sub-phase of pre-processing the selected set of documents thereby resulting in the transformation from a given input form to an intermediate form. By way of example, and in no way limiting the scope of the invention, each of the selected set of documents is subjected to transformation from the given input form to the intermediate form. Details in connection with the pre-processing the selected set of documents facilitated through implementation of the document pre-processing sub-module 218 have already been delineated in conjunction with FIG. 2.

At stage 410, the phase of pre-parsing comprises the sub-phase of searching the one or more selected documents thereby resulting in discovery (or location or detection) of one or more PDTs. In certain situations, the search relies on seeking quoted items in the text of a given selected document. For example, ,,“Portfolio”“ means a portfolio of loan securities. Still, in certain situations, opened but not closed quotes are identified by a DTs name not exceeding a certain length. Specifically, looping through each word in the given document, one or more ranges or arrays of words that are at least of bold within a non-bold section and italic within a non-italic section are selected. All other ins-and-outs in connection with the discovery (or location or detection) of one or more PDTs facilitated through implementation of the intra-document PDT search sub-module 220 have been already delineated in conjunction with FIG. 2.

At stage 412, the phase of pre-parsing comprises the sub-phase of testing one or more PDT ranges for existence and validation of one or more definitions. Specifically, for a given PDT the test for existence and validation of definition comprises selection of a given paragraph to which a given PDT range is confined to. In certain circumstances, one or more paragraphs are selected to which one or more PDT ranges are confined to. Specifically, in certain such circumstances, the paragraph selection may be extended to include one or more consecutive or contiguous paragraphs to capture a given definition, which extends over one or more paragraphs. All other ins-and-outs in connection with the testing one or more PDT ranges for existence and validation of one or more definitions facilitated through implementation of the PDT test sub-module 222 have been already explained in conjunction with FIG. 2.

At stage 414, the phase of pre-parsing comprises the sub-phase of splitting of given one or more paragraphs into one or more portions, in accordance with the principles of the invention. By way of example, and in no way limiting the scope of the invention, a given paragraph is split into three sections. For purposes of clarity and expediency, the three sections of the selected paragraph have been mentioned herein as a Prefix Range, a Keyword Range and a Postfix Range, in that order.

The term “Keyword Range”, as used in the current context, refers to a given Potential Defined Term Range (or PDTR) adapted to discard or ignore all punctuation characters, barring at least a pair of definition delimiters positioned at the start and end of the given PDTR.

Further, as used in the current context, the term “Prefix Range” refers to everything in a given selected paragraph prior to the Keyword Range.

Still further, as used in the current context, the term “Postfix Range” refers to everything in a given selected paragraph subsequent to the Keyword Range. All other ins-and-outs in connection with the splitting of one or more paragraphs facilitated through implementation of the paragraph splitter component 226 have been already explained in conjunction with FIG. 2.

At stage 416, the phase of pre-parsing comprises the sub-phase of generation of one or more DMTs. By way of example, and in no way limiting the scope of the invention, a given DMT is generated by concatenation of the given Prefix Range, “xKeywordx” and Postfix Range. In certain specific situations, if a given Keyword Range satisfies at least one of one or more criterion then it is ignored and discarded as a Potential definition. For example, and by no way of limitation, the one or more criterion associated with the given Keyword Range is at least one of empty Keyword Range, is a single character Keyword Range, is a Keyword Range beginning with a lowercase character. All other ins-and-outs in connection with the aforementioned generation of one or more DMTs facilitated through implementation of the DMTG component 228 have been already explained in conjunction with FIG. 2.

At stage 418, the phase of pre-parsing comprises the sub-phase of generation of one or more rules for construction of one or more RegExs. By way of example, and in no way limiting the scope of the invention, a pair of rules, namely RegEx Rule 1 and RegEx Rule 2, is implemented for the construction of at least a pair of RegExs. Details in connection with the generation of one or more rules for construction of one or more RegExs facilitated through implementation of the RRG component 230 have been already explained in conjunction with FIG. 2.

At stage 420, the phase of pre-parsing comprises the sub-phase of comparison of one or more DMTs versus one or more RegExs. In certain specific embodiments, a given DMT is compared versus a pair of RegExs generated through implementation of the pair of rules, namely RegEx Rule 1 and RegEx Rule 2. By way of example, and in no way limiting the scope of the invention, the RegEx Rule 1 is illustrated by the following Expression 1:

̂((\w+\s*) {0,3} |.+ or ) [“,,”“]?xKEYWORDx[“,,”“]?\s* (or|means|is|has the meaning|[:]),

Likewise, the RegEx Rule 2 is illustrated by the following Expression 2:

[(](\w+\s*) {0,3} [“,,”“]?xKEYWORDx[“,,”“]?[)].

Details in connection with the comparison of one or more DMTs versus one or more RegExs facilitated through implementation of the comparator component 232 have been already explained in conjunction with FIG. 2.

In certain situations, a given DMT matches one or more RegExs. In such situations, the DMT is considered a definition and added to an object model. Further, the Prefix Range and Postfix Range are taken as the definition's definition text whereas the Keyword Range is used as the DT.

Still, in certain situations involving multiple definitions in a given paragraph, the definition text of a given prior definition is adjusted to finish on its Keyword Range.

As used in the current document, the term “object model” refers to a set comprising one or more objects or entities in which each of the one or more objects comprises one or more fields (or attributes). Further, each of the one or more fields is characterized by a field type (or object description) and a field identifier (or name).

Table 2 is a tabular representation of example object model, designed and implemented in accordance with the principles of the invention.

| | OBJECT DESCRIPTION/ | |
|---|---|---|
| OBJECT/ENTITY | FIELD TYPE | FIELD NAME |
| DefinitionInstance | A definition (definition | |
| | text + defined term) of a | |
| | defined term. Each | |
| | DefinitionInstance is | |
| | associated with one and | |
| | only one Definition. | |
| | Document | containerDocument |
| | Definition | parentDefinition |
| | String | id |
| | String | keyword |
| | int | page |
| | List<String> | wordList |
| | String | description |
| Bundle | A set of related | |
| | documents. | |
| Document | A document. | |
| Definition | A defined term together | |
| | with zero or more | |
| | definitions (object | |
| | model name | |
| | DefinitionInstance). | |
| | Bundle | containerBundle |
| | String | id |
| | String | keyword |
| | String | compositeKeyword |
| | List<String> | words |
| | List<DefinitionInstance> | instances |
| | List<Definition> | referredDefinitions |
| | List<DefinitionInstance> | referrerDefinitionInstances |
| | List<Reference> | inTextReferrers |
| Reference | A use or reference to a | |
| | given defined term. | |
| | Bundle | containerBundle |
| | Document | containerDocument |
| | String | id |
| | int | page |
| | Definition | referTo |
| | DefinitionInstance | referrer |
| Bundle | | |

In certain specific embodiments, the aforementioned search sub-phases facilitate construction of a data model of a given document, which consists of a plurality of DT objects, which in turn include references between DT objects and references to the text. In such embodiments, one or more links are analyzed between the DTs to complete the object model.

At stage 422, the process comprises the phase of generation of an object model for given one or more documents in a given document set utilizing a given data model. Specifically, the one or more links are analyzed between the DTs to complete the object model.

As used in the current context, the phrase “links are analyzed” loosely refers to the process of merging given one or more DT object models between given one or more documents in a given document set and finalizing any items in the object model.

In certain embodiments, the process comprises the phase of usage analysis of the DTs.

In certain specific embodiments, the phase of usage analysis comprises implementation of all potential permutations and combinations of one or more sub-phases in one or more distinct sequences, in accordance with the principles of the invention.

At stage 424, the phase of usage analysis comprises the sub-phase of implementation of a fast lookup facility, designed in accordance with the principles of the invention. In certain embodiments, to facilitate fast lookup one or more definitions are put into a given index structure by number of words in a given DT and then alphabetically by the DT.

In certain embodiments, the phase of usage analysis comprises the sub-phase of implementation of a queue data structure, designed in accordance with the principles of the invention. By way of example, and in no way limiting the scope of the invention, the queue data structure is an ordered FIFO queue. Specifically, each word in a given document is added to the ordered FIFO queue of length MaxWord.

At stage 426, the phase of usage analysis comprises the sub-phase of generation of one or more stemmed composite words from the ordered FIFO queue. In certain situations, MaxWord number of stemmed composite words are generated from the ordered FIFO queue using a given first word, first word +second word and so on to all words in the ordered FIFO queue.

As used in the current context, the term “stemmed” refers to taking into consideration a mapping from a given original word into the stem of the original word using a local language spelling module and dictionary.

At stage 428, the phase of usage analysis comprises the sub-phase of searching usage of one or more DTs. In certain situations, each generated stemmed composite word is considered in order of decreasing number of words (i.e. longest first) and if it is found in the index structure then a definition reference, also called a reference, is recognized as found and appropriate additions are made to the object model. In such situations, if a given search is successful then the remaining searches are skipped and ignored.

Further, in such situations, no stemmed composite words are generated until the queue is full, i.e. at MaxWord length.

Still, in such situations, fewer stemmed composite words are generated at the end of document reading, if the queue is not full.

In certain other situations, if any of the words in the queue are inside a keyword of a definition (i.e. the DT) then the stemming and search states are skipped and the next word iterated in.

Yet, in certain other situations, if the first word in the queue is not capitalized then the stemming and search sub-phases are skipped and the next word iterated in.

In certain specific embodiments, the search is done by binary search.

In certain embodiments, the object model additions are as follows. A Reference object is created and is added to the relevant Definition object. It is also added to the relevant DefinitionInstance object, if the reference is within the definition text of that DefinitionInstance. In here, the words stored within the Reference object are trimmed of any trailing spaces.

By way of example, and in no way limiting the scope of the invention, if a given original word stream is “With all Additional Machine Tools”, then “Additional Machine Tool” is a DT and MaxWord value is 3.

In certain implementation scenarios, a first compared queue may contain “With all Additional” and would stem to “With all Additional”, “With all” and “With”. Thus, no matches may occur.

In certain other implementation scenarios, a second compared queue may be “all Additional Machine”, which may be ignored as first word is not capitalized.

Still, in certain exemplary instances, a third compared queue may be “Additional Machine Tools”, which would stem to “Additional Machine Tool”, “Additional Machine” and “Additional”. The first stem, i.e. “Additional Machine Tool” may be found in the index and so it may be added as a reference.

Note in the example versus actual implementation, the actual word separator used is “x”, not “ ” and the word stemming may not have been represented faithfully to the implementation.

Eventually, in certain other exemplary instances, if none of the stemmed composite words are found in the search stage and the first word does not begin a sentence then if any original (i.e. non-stemmed) composite words (again examining in order of length, longest first) are all capitalized (i.e. beginning with uppercase letters and continuing in lowercase letters) then such original composite word is considered a DT and added as a Definition and Definition Instance without a definition text.

In certain embodiments, methods for searching one or more references to Defined Terms (or DTs) in documents are disclosed, in accordance with the principles of the invention. In certain such embodiments, design and implementation of methods for searching one or more references to Defined Terms (or DTs) in documents using one or more tree data structures are disclosed. Further, in certain such embodiments, design and implementation of one or more tree data structures thereby facilitating fast lookup for references to Defined Terms (or DTs) in documents are disclosed. By way of example, and in no way limiting the scope of the invention, design and implementation of one or more trees facilitate fast lookup of one or more references to one or more DTs in one or more documents.

In certain specific embodiments, a method for managing references to defined terms in documents, the method comprising creating a tree of defined terms found in at least one of a plurality of documents using stemmed words of the defined terms and implementing the tree for facilitating fast lookup for the references to the defined terms. By way of example, and in no way limiting the scope of the invention, design and implementation of one or more trees facilitate fast lookup of one or more references to one or more DTs in one or more documents.

In certain such specific embodiments, a first level of the tree contains each of first stemmed words of the each of the defined terms as one or more child nodes thereof. Further, each of the one or more child nodes in the first level has one or more child nodes in a second level containing each of second stemmed word of the each of the defined terms, wherein each of the one or more child nodes in a second level has each of the one or more child nodes in the first level as parent nodes. Still further, an n-th level of the tree contains each of the n-th stemmed word of the each of the defined terms. Furthermore, each node of the tree corresponds to at least one of a defined term, a middle word in the defined term and the root node of the tree.

In use, in certain such specific embodiments, the phase of implementing the tree for facilitating fast lookup for the references to the defined terms in the documents involves examination of each word thereof. Specifically, in use, in certain such specific embodiments, the phase of implementing the fast lookup for facilitating for the references to the defined terms in the documents involving examination of each word thereof comprises implementation of at least one of the one or more distinct phases and all potential permutations and combinations of the phases thereof, in accordance with the principles of the invention. By way of example, and in no way limiting the scope of the invention, the phase of implementing the fast lookup for facilitating for the references to the defined terms in the documents involves implementation of the following phases assigning the root node of the tree as a current node and a first word of the document as a current word, assigning the current node to the child node on determining a stemmed word of the current word is a child node of the current node, declaring that a reference is found on determining the stemmed word of the current word is not a child node of the current node and the current node corresponds to a defined term, resetting the current node to the root node on determining the stemmed word of the current word is not a child node of the current node, assigning the current word to a next word and reiterating the phases of the assigning the current node to the child node on determining a stemmed word of the current word is a child node of the current node, the declaring that a reference is found on determining the stemmed word of the current word is not a child node of the current node and the current node corresponds to a defined term and the resetting the current node to the root node on determining the stemmed word of the current word is not a child node of the current node.

Advantageously, in certain enhanced embodiments, one or more additional features have been incorporated through design and implementation one or more methods, in accordance with the principles of the invention, while still abiding by the spirit and scope of the invention and the claims appended hereto. For example, and in no way limiting the scope of the invention, in use, the ATDGVS can look for definition instances ending in a paragraph subsequent to the one it begins on.

Further, in use, the ATDGVS also checks for “Ambiguous Orphan Terms” (or AOT or “Undefined Terms”) using an appropriate scoring technique during implementation of tree walk or traversal, in accordance with the principles of the invention.

As disclosed earlier, the ATDGVS implements a set of rules which gives appropriate score adjustment to one or more distinct categories. By way of example, and in no way limiting the scope of the invention, the following are one or more known or given categories: ““Ambiguous Orphan Term”,” ““Address”,” ““Company Name”,” ““Date”,” ““Country”,” “Corporate Title”,” ““Common Legal Act”,” ““Name”,” and the like.

In use, the category with the top score becomes or is allocated the assigned category for a given term. Further, one or more categories or scores checked for a limited length from a given, selected current document position (e.g. “MaxWords”) and the longest term variation (with a category score hitting some predefined threshold value) picked as some “KNOWN” term with some category defined above (e.g. a pick with the category “Ambiguous Orphan Term” becomes an AOT, all others are simply skipped). AOT's picked this way are put into the Definition list. To identify the AOT as a reference, current document position (search state) is reset to the beginning of the originating term to let DT lookup find the AOT just added to definition list.

The invention is intended to cover all equivalent embodiments, and is limited only by the appended claims. Various other embodiments are possible within the spirit and scope of the invention. While the invention may be susceptible to various modifications and alternative forms, the specific embodiments have been shown by way of example in the drawings and have been described in detail herein. The aforementioned specific embodiments are meant to be for explanatory purposes only, and not intended to delimit the scope of the invention. Rather, the invention is to cover all modifications, equivalents, and alternatives falling within the spirit and scope of the invention as defined by the following appended claims.

What is claimed is:

1. A method for automated graphical visualization of defined terms in text document, comprising acts of,
searching defined terms, defined terms usages and defined term's definition text in the text document;
analyzing links between the defined terms; and
representing graphically the defined terms and links between the defined terms of the text document.

2. The method of claim 1, wherein the act of searching defined terms and defined terms usages comprises pre-parsing of the text document to extract formatting and text information from the text document.

3. The method of claim 2, wherein the pre-parsing extracts formatting and text information comprising open, close quotes, parentheses, brackets, bold formatting, heading formatting, pagination and text including punctuation.

4. The method of claim 3, wherein searching defined term comprising looking for quoted items in the text.

5. The method of claim 3, wherein searching defined term usages comprises searching for capitalized letters indicative of a defined term being used.

6. The method of claim 1, wherein searching defined term's definition text comprising finding text of a defined term, wherein the text of a defined term is the definition of that defined term.

7. The method of claim 2, wherein pre-parsing comprising looping through each word in the text document and selecting those ranges of word that are bold within a non-bold section or italic within a non-italic section of the text document, wherein the range is a potential defined term range.

8. The method of claim 7, further comprising testing each potential defined term range to check if it is a definition.

9. The method of claim 8, wherein testing act comprising selecting a paragraph from the text document that the potential defined term belongs to, splitting the paragraph into three sections comprising prefix range, keyword range and postfix range and constructing a definition match text as prefix range concatenated with keyword range and postfix range.

10. The method of claim 9, further comprising comparing the definition match text to a set of regular expressions to check if it is a definition.

11. The method of claim 10, wherein the set of regular expressions comprising quotes, quotes and bold, bold only or table style.

12. The method of claim 11, further comprising considering a definition match text a definition if it matches one or more regular expressions and adding to the object model and ignoring if it does not match one or more regular expressions.

13. The method of claim 12, further comprising using the keyword range of the definition match text as a defined term, using the prefix range and postfix range as the defined term's definition and adding to the object model.

14. The method of claim 1, wherein the act of analyzing links between the defined terms comprising generating a data model of the document by employing defined terms and defined terms usages.

15. The method of claim 14, comprising putting the definitions into an index structure by employing number of words in defined term and then alphabetically by defined term.

16. The method of claim 15, further comprising iterating through each word in the text document and adding the word to an ordered FIFO queue of length MAXWORDS, wherein MAXWORDS is the largest number of words in a defined term across the text document.

17. The method of claim 16, further comprising generating MAXWORDS number of stemmed composite words from the queue by first using the first word in the queue followed by first word and second word and finally all words in the queue, wherein stemmed composite words comprising taking a mapping from the original word into the stem of the original word, using a local language spelling module and dictionary.

18. The method of claim 17, further comprising considering each generated composite word in order of decreasing number of words, checking if it is in the index, recognizing a definition reference as found if it is in the index, adding the definition reference to the object data model and skipping remaining searches if a successful search is made.

19. The method of claim 18, wherein a reference object is created and is added to the relevant definition object and to the definition instance object, if the reference is within the definition text of that definition instance.

20. The method of claim 1, wherein the graph displays a tree with nodes, wherein the tree initially shows only the top level nodes, wherein each node can be opened individually to show next level down of nodes, wherein a node represents a defined term or definition of the text document.

21. The method of claim 1, further comprising, upon selecting a node in the graph by a user, the graph of that node with its next level down nodes and up nodes is shown, wherein the defined term belonging to the selected node becomes the central node and brings up the information on the selected node.

22. The method of claim 21, wherein next level down and up nodes are shown according to a user defined generations depth, wherein, the generations depth is up or down or both.

23. The method of claim 21, wherein a node representing a defined term in the document and links between the nodes show which defined term uses which defined term in its definition text.

24. The method of claim 1, further comprising hovering over a defined term in the graph bringing up a pop-up with some additional information on the defined term.

25. The method of claim 1, the graph further showing a definition list of all definitions in the text document, with a search feature to speed lookup.

26. The method of claim 6, wherein upon selecting a defined term in a definition list of the graph, displaying the definition of the defined term in a definition box.

27. The method of claim 1, the graph further displaying a used on pages box showing which pages a defined term is used in the text document, wherein clicking on a page link shows the relevant page of the text document.

28. The method of claim 1, the graph further displaying number of uses of a defined term in the text document.

29. A computer readable medium having stored thereon computer executable instructions that when executed by a processor of a computer, performs acts comprising:
searching defined terms, defined terms usages and defined term's definition text in the text document;
analyzing links between the defined terms; and
representing graphically the defined terms and links between the defined terms of the text document.

30. A method for organizing definitions of documents, the method comprising,
pre-parsing the document to extract formatting information of the document;
searching definitions, definition's text and references of definitions in the document;
analyzing relationships between the definitions; and
displaying definitions and relationships between the definitions in a graphical tree-structure.

31. A computer-implemented system for automated graphical visualization of definitions in documents, the system comprising,
a searching component that searches definitions, definition's text and definition's references in the document;
an analysis component that analyzes references between the definitions; and
a display component that displays definitions and references between the definitions in a graphical tree-structure.

32. A method for managing references to defined terms in documents, the method comprising:
creating a tree of defined terms found in at least one of a plurality of documents using stemmed words of the defined terms; and
implementing the tree for facilitating fast lookup for the references to the defined terms.

33. The method of claim 32, wherein a first level of the tree contains each of first stemmed words of the each of the defined terms as one or more child nodes thereof.

34. The method of claim 33, wherein each of the one or more child nodes in the first level has one or more child nodes in a second level containing each of second stemmed word of the each of the defined terms, and wherein each of the one or more child nodes in a second level has each of the one or more child nodes in the first level as parent nodes.

35. The method of claim 32, wherein an n-th level of the tree contains each of the n-th stemmed word of the each of the defined terms.

36. The method of claim 32, wherein each node of the tree corresponds to at least one of a defined term, a middle word in the defined term and the root node of the tree.

37. The method of claim 32, wherein the phase of implementing the tree for facilitating fast lookup for the references to the defined terms in the documents involves examination of each word thereof.

38. The method of claim 37, wherein the phase of implementing the fast lookup for facilitating fast lookup for the references to the defined terms in the documents involving examination of each word thereof comprises:
1. assigning the root node of the tree as a current node and a first word of the document as a current word;
2a. assigning the current node to the child node on determining a stemmed word of the current word is a child node of the current node;
2b. declaring that a reference is found on determining the stemmed word of the current word is not a child node of the current node and the current node corresponds to a defined term;
2c. resetting the current node to the root node on determining the stemmed word of the current word is not a child node of the current node;
3. assigning the current word to a next word; and
4. reiterating phases 2a-2c.
